(19) United States
(12) Patent Application Publication
(10) Pub. No.: US 2026/0326997 A1
(43) Pub. Date: Oct. 22, 2026

(54) LOCKABLE THERMALLY INSULATED PACKAGE

(71) Applicant: DGP INTELSIUS LIMITED, York (GB)

(72) Inventors: Jens MANGELSEN, York (GB); Richard MERCHANT, York (GB)

(21) Appl. No.: 19/109,786

(22) PCT Filed: Sep. 7, 2023
(86) PCT No.: PCT/GB2023/052317

§ 371 Date: Mar. 7, 2025

(30) Foreign Application Priority Data
Sep. 8, 2022 (GB) 2213156.9

(51) Int. Cl. B65D 81/38; B65D 55/02; B65D 79/02; G01K 1/024

(52) U.S. Cl. CPC B65D 81/3813; B65D 55/02; B65D 79/02; G01K 1/024

(57) ABSTRACT

A lockable thermally insulated package for transporting a temperature sensitive payload. The thermally insulated package comprises a payload retention volume, at least one layer of insulation surrounding the payload retention volume, a main body enclosing the at least one layer of insulation and the payload retention volume, wherein the main body comprises an openable panel, a restraining member for retaining the openable panel in a closed position and a functional device having a locked state and an unlocked state. The functional device is configured to engage with the restraining member and selectively hold the restraining member against the openable panel in a closed position when the functional device is in the locked state and to selectively release the restraining member when the functional device is in the unlocked state. A kit for assembling such a thermally insulated package and a method of transporting a temperature sensitive payload are also described.

### FIELD

The present invention relates to a thermally insulated package for transporting a temperature sensitive payload and to a thermally insulated package kit and a method of transporting a temperature sensitive payload. In particular the invention relates to a thermally insulated package which is lockable by a functional device to improve the security and monitoring of the transportation of temperature sensitive payloads.

### BACKGROUND

The transportation of temperature sensitive goods requires the use of packaging which can maintain the temperature of the temperature sensitive goods within a pre-determined range. This may be achieved by providing a packaging item with insulation, either in the form of loose insulation material or by constructing a rigid box out of an insulating material. For example, rigid insulating boxes made from polystyrene foam have been used for many years to transport various temperature sensitive goods such as medical supplies and biological samples.

Temperature sensitive goods, such as biological material, may be of high value in terms of cost and also in terms of the importance of the goods to the recipients, for example medical practitioners or researchers. In many cases, the temperature sensitive goods will only be accepted for their intended purpose if their temperature has been maintained within a specified range during transportation, for example to ensure the quality and safety of the temperature sensitive goods. Therefore it advantageous to monitor the internal temperature of such thermally insulated packages during transportation.

Current methods of monitoring the temperature of a thermally insulated package used for transporting such temperature sensitive goods involve placing temperature recording equipment inside the payload retention volume of the thermally insulated package, in order to record the internal temperature of the package, or by attaching such a device to the outside of the package and arranging a temperature sensor within the payload retention volume. This recorded temperature data can then be viewed after the thermally insulated package has been received and opened, in order to check whether the temperature specified for those temperature sensitive goods has been maintained during transportation. If the specified temperature has not been maintained, then the recipient may reject the temperature sensitive goods.

In such current thermally insulated packages, it is possible for a user to open the package before it has reached its destination. A user may do this to check on the contents or to tamper with or steal the contents. Opening the thermally insulated package in this way may increase the internal temperature of the package and adversely affect temperature sensitive contents. With such an openable package it may not be possible for a logistics provider to guarantee that ideal transportation conditions have been maintained throughout transportation.

Therefore it would be beneficial if the security of such thermally insulated packages could be improved.

### SUMMARY OF THE INVENTION

It is one aim of the present invention, amongst others, to provide a thermally insulated package that addresses at least one disadvantage of the prior art, whether identified here or elsewhere, or to provide an alternative to existing thermally insulated packages. For instance it may be an aim of the present invention to provide a thermally insulated package which has improved security compared to known thermally insulated packages.

According to aspects of the present invention, there is provided a thermally insulated package, a kit and a method as set forth in the appended claims. Other features of the invention will be apparent from the dependent claims, and the description which follows.

According to a first aspect of the present invention, there is provided a thermally insulated package for transporting a temperature sensitive payload, the thermally insulated package comprising:
a payload retention volume;
at least one layer of insulation surrounding the payload retention volume;
a main body enclosing the at least one layer of insulation and the payload retention volume, wherein the main body comprises an openable panel;
a restraining member for retaining the openable panel in a closed position; and
a functional device having a locked state and an unlocked state;
wherein the functional device is configured to engage with the restraining member and selectively hold the restraining member against the openable panel in a closed position when the functional device is in the locked state and to selectively release the restraining member when the functional device is in the unlocked state.

The engagement of the restraining member with the functional device allows the thermally insulated package to be locked by the functional device when the restraining member is appropriately arranged on the openable panel of the main body of the package. This locking of the package can help ensure that the thermally insulated package is not interfered with during transport or unintentionally opened before reaching its destination, which may adversely affect a temperature sensitive payload being transported in the package. The thermally insulated package of this first aspect can therefore improve the reliability and security of cold chain logistics. These principles apply equally to the transport of payloads which must be kept at temperatures below ambient temperature and payloads which must be kept at temperatures above ambient temperature, for example some medical supplies which must be kept at approximately human body temperature.

The closed position of the openable panel is where the openable panel is arranged on the main body of the thermally insulated package and the package is closed and substantially sealed from the ingress of atmospheric air, in order to maintain a desired temperature in the payload retention volume.

An open position of the openable panel may be where the openable panel is partially or completely separated from the main body of the package to allow a user to access the payload retention volume.

The selective release of the restraining member by the functional device allows the openable panel to be opened by a user to gain access to the payload retention volume, which may involve removing some parts of the at least one layer of insulation from the thermally insulated package. Therefore the operation of the functional device in conjunction with the restraining member allows the thermally insulated package to be selectively opened/unlocked and closed/locked.

In addition to the locking function described above, the functional device may also be configured for temperature monitoring, location determination, physical condition or event monitoring and/or communication. Suitably the functional device is configured to record and/or communicate an internal parameter of the thermally insulated package. Therefore in addition to the locking function described above, the functional device can also operate to record and/or communicate an internal parameter of the thermally insulated package, for example a temperature in the payload retention volume. Suitable configurations for recording and/or communicating such internal parameters are known in the art. Such devices are known in the art as data loggers. The functional device used in the thermally insulated package of this first aspect is therefore suitably a data logger with additional locking functionality.

The functional device may include or be connected to any one of more of the following: a temperature sensor, a light sensor, a shock sensor, an orientation sensor, an acceleration sensor, a speed sensor and a pressure sensor.

Such embodiments wherein the functional device has the additional data logger functionalities described above may be particularly advantageous. Many thermally insulated packages now use data logger devices for monitoring the temperature and other parameters of the package in transit so combining the locking feature of the functional device described herein with such data logger functions into one device means that no additional functional device needs to be attached to the package, simplifying the construction and use of the package and therefore improving efficiency and potentially lowering costs.

Suitably the thermally insulated package comprises only one functional device. Therefore the package suitably does not comprises a further functional device or data logger in addition to the functional device having the locking feature discussed herein.

Suitably the thermally insulated package is configured to allow wireless communication between the functional device and a sensor in the payload retention volume. For example, the materials used to provide the layer or layers of insulation are suitably chosen to allow wireless communication between the functional device and the payload retention volume.

Suitably said functional device comprises a wireless communication module adapted to receive one or more data signals from said sensor or sensors inside the payload retention volume. By using a wireless communication module, said functional device can advantageously receive a data signal from a sensor inside the payload retention volume wirelessly (if said sensor is adapted to transmit said data signals wirelessly) and therefore without compromising the thermally insulating properties of said thermally insulated package. If wiring for said temperature sensors was routed through or between thermally insulating panels of the thermally insulated package then the insulating properties of the package may be adversely affected.

Suitably the thermally insulated package is configured to allow short-range and long-range wireless communication (e.g. Bluetooth/2G/3G/4G/GPS/WAN) through the layer or layers of insulation and the outer casing. Therefore the layer or layers of insulation and the main body are suitably chosen to allow said short-range and long-range wireless communication. In particular, the outer casing is suitably formed of a material which allows said long-range wireless communication.

In some embodiments, the thermally insulated package comprises a channel through which a wire can pass from the functional device to the payload retention volume, suitably to allow said functional device to be connected to a sensor in the payload retention volume. For example the payload retention volume may comprise a wired thermocouple for connection to said functional device. The channel may be arranged at an edge of insulating panels which provide the at least one layer of insulation material.

Suitably the thermally insulated package comprises a sensor selected from one or more of a temperature sensor, a light sensor, a shock sensor, an orientation sensor, an acceleration sensor, a speed sensor and a pressure sensor, within the payload retention volume. Suitably the thermally insulated package comprises a location sensor. Suitably the thermally insulated package comprises a temperature sensor and a location sensor.

Suitably the thermally insulated package comprises a temperature sensor within the payload retention volume.

Suitably the functional device comprises a data storage module adapted to record internal and temperature data obtained from said temperature sensor.

Suitably the functional device comprises a data storage module adapted to record data obtained from any one or more of the sensors which may be present in the thermally insulated package, suitably selected from a temperature sensor, a light sensor, a shock sensor, an orientation sensor, an acceleration sensor, a speed sensor, a pressure sensor and a location sensor. The functional device is suitably switchable between the locked state and the unlocked state.

The switching of the functional device between the locked and unlocked state may be controlled by a user directly operating the functional device, for example through a touch screen, by a timer function or by command signal from a remote source. The functional device may be configured to, once locked, switch from the locked state to the unlocked state only when a timer has elapsed or when a command signal has been received by the functional device from a remote source.

Suitably the data storage module discussed above is adapted to record instances of the functional device being switched between the locked state and the unlocked state, i.e. to record locking and unlocking events. Suitably the thermally insulated package comprises a temperature sensor and a location sensor and is adapted to record instances of the functional device being switched between the locked state and the unlocked state.

Suitably the functional device is configured for remote operation by a command signal to selectively switch the functional device between the locked state and the unlocked state. In some embodiments, the functional device is configured to only be operable to selectively switch between the locked state and the unlocked state by said command signal from a remote source.

Suitably the functional device is configured to receive command signals in the form of short-range and long-range wireless communications, for example Bluetooth, 2G, 3G, 4G, 5G, GPS or WAN signals. The functional device may therefore comprise a suitable telecommunications unit for receiving said command signal. Suitably the functional device is configured to send and receive said types of signal, suitably through an appropriate telecommunications unit. In such embodiments, the thermally insulated package can suitably be unlocked by a remote user, for example when the remote user is satisfied that the thermally insulated package has reached its intended destination. Suitably the thermally insulated package can only be unlocked by a remote user providing the command signal to switch the functional device from the locked state to the unlocked state, as discussed above.

The functional device is suitably adapted to communicate data obtained from the one or more sensors discussed above and/or instances of the functional device being switched between the locked state and the unlocked state, to a remote user. The functional device suitably comprises the telecommunications unit discussed above to enable the device to send said data by short-range and/or long-range wireless communications. This functionality suitably allows the thermally insulated package to be tracked and traced in real-time for monitoring and auditing purposes, which may be important for temperature sensitive payloads. For example, such functionality allows the location, temperature and locking/unlocking event data to be correlated so that a user can determine the time and location of such locking/unlocking events and any temperature changes.

Suitably, the thermally insulated package comprises a temperature sensor inside the payload retention volume and a location sensor, and the functional device is adapted to communicate data from the temperature sensor and the location sensor, to a remote user.

Suitably the functional device is adapted to communicate data relating to the temperature and location of the thermally insulated package and instances of the functional device being switched between the locked state and the unlocked state to a remote user.

Suitably the functional device is adapted to communicate data from a temperature sensor inside the payload retention volume of the thermally insulated package, from a location sensor in the thermally insulated package and of recorded instances of the functional device being switched between the locked state and the unlocked state, to a remote user, suitably with associated time/date information for said data. Such functionality of the functional device allows a seamless audit trail to be created for the thermally insulated package during transportation, which can be monitored in real time.

The functional device may be adapted to communicate an alert to a remote operator if the functional device detects that the functional device itself, the restraining member or the openable panel have been removed from the package, or if an attempt has been made to unlock the functional device, remove the restraining member or open the openable panel. The functional device may be configured to send said alert if it detects said actions before the command signal has been sent to by the remote user to switch the functional device from the locked state to the unlocked state. The functional device may be configured to detect said actions by the incorporation of appropriate sensors, such as motion, pressure or light sensors. The functional device suitably comprises the telecommunications unit discussed above to enable the device to send said alert by short-range and/or long-range wireless communications.

Said remote operator may then interpret the alert and communicate said alert to a driver of a vehicle transporting said thermally insulated package, or to another appropriate user involved in the transportation of the thermally insulated package, in order for them to take appropriate action.

Alternatively or additionally, the alert may be provided as an audible and/or visual alert, for example an audible alert emitted from a speaker module arranged in the device and/or a visual alert displayed on the device, for example on a display screen or a warning light arranged on the device.

The functional device may be configured to provide said alert to a driver of a vehicle transporting the thermally insulated package, for example by short range wireless communication.

The functional device is suitably removable from the thermally insulated package when in the unlocked state. The functional device is suitably removable from the restraining member when in the unlocked state.

Suitably the functional device is received in a recess of the thermally insulated package. Suitably openable panel comprises the recess for receiving the functional device.

Suitably the functional device is configured to be secured to the openable panel and the restraining member when in the locked state, when the openable panel is in a closed position and the restraining member is appropriately arranged on the openable panel.

The functional device suitably comprises locking members which engage with the restraining member when the functional device is in the locked state, when the openable panel is in a closed position and the restraining member is suitably arranged against the openable panel. When the restraining member is so arranged against the openable panel to hold the openable panel in the closed position, the restraining member may also be said to be in a closed position.

The locking members may be retractable pistons which are retracted when the functional device is in the unlocked state and are extended when the functional device is in the locked state. Additionally or alternatively, the locking members may be retractable hooks which are retracted when the functional device is in the unlocked state and are extended when the functional device is in the locked state.

The restraining member is suitably configured to receive the locking members of the functional device. For example, the restraining member may comprise through holes for receiving the locking members of the functional device. The restraining member may alternatively or additionally comprise at least one loop which engages the locking members of the functional device, such as retractable hooks.

The restraining member suitably comprises at least one engagement portion for engaging with the functional device, when the functional device is in the locked state. The engagement portion may be provided by a plate and may comprise the through holes and/or loops as discussed above for receiving and locking to the locking members of the functional device.

The openable panel may comprise a recess for receiving the engagement portion of the restraining member. The recess in the openable panel may be configured to receive the engagement portion of the restraining member and the functional device. Suitably, placement of the engagement portion of the restraining member and the functional device in the recess of the openable panel aligns the locking members with the engagement portion to allow the functional device to lock onto the restraining member, when the locked state of the functional device is activated.

Suitably the restraining member comprises a flexible portion. For example, the restraining portion may comprise a strap or netting. The flexible portion can suitably be placed over the openable panel to secure the openable panel in the closed position, when the restraining member is locked to the functional device. The restraining member suitably comprises a flexible portion and a rigid engagement portion.

The restraining member is suitably configured to engage with a tether distal from the engagement portion and functional device. The engagement portion of the restraining member is suitably connected to the tether by the flexible portion. When the functional device is in the locked state, is engaged with the restraining member and is arranged on the openable panel to lock the thermally insulated package, the flexible portion suitably connects the locked functional device to the tether and therefore secures the openable panel in the closed position against the main body of the package.

In some embodiments, the thermally insulated package comprises at least one tether for receiving the restraining member, suitably arranged on the main body of the package. The tether is suitably arranged on a base panel of the main body of the package.

In some embodiments, the restraining member is configured to connect to a tether which is external to the thermally insulated package. Such an external tether may be provided on a floor of a transportation vehicle, for example. The restraining member may be connectable to the external tether by a hook or similar means.

Suitably the thermally insulated package comprises at least two restraining members which connect to the functional device when the restraining member is in the closed position and the functional device is in the locked state, as described above. Suitably the at least two restraining members comprise flexible portions as discussed above. Suitably the at least two restraining members are each configured to be connected to a separate tether. In some embodiments, the thermally insulated package comprises at least two tethers, suitably arranged on a base of the main body of the package, each for receiving one of the at least two restraining members.

Suitably the at least two restraining members each comprise engagement portions as discussed above. Suitably the engagement portions are configured to meet at the functional device, when the functional device is in the locked state, is engaged with the restraining members and is arranged on the openable panel to lock the thermally insulated package.

The restraining member or members are suitably appropriately sized to fit tightly onto the main body of the package when the engagement portion or portions are engaged with the functional device to lock the package.

In some embodiments, the restraining member wraps around the base of the thermally insulated package. Suitably the restraining member is retained in or on the base of the package, for example in a groove or channel. In such embodiments, the restraining member may be a single strap having two ends comprising engagement portions which are configured to meet at the functional device, as discussed above. In such embodiments a tether is not required.

In the thermally insulated package of this first aspect, the at least one layer of insulation surrounding the payload retention volume suitably comprises vacuum insulated panels and/or phase-change material containing vessels. For the avoidance of doubt, for the purposes of this invention, phase-change material containing vessels are considered to be insulation component and therefore considered to form a layer of insulation when such vessels are appropriately arranged in the thermally insulated package.

Suitably the thermally insulated package comprises more than one layer of insulation surrounding the payload retention volume. Suitably the thermally insulated package comprises at least two layers of insulation surrounding the payload retention volume. Therefore the thermally insulated package may comprise a first layer of insulation which surrounds the payload retention volume and a second layer of insulation which surrounds the first layer of insulation. Both the first and second layers of insulation are suitably inside the main body of the package and outside of the payload retention volume.

The thermally insulated package may comprise a layer of insulation provided by vacuum insulated panels. The vacuum insulated panels may be provided by discrete, separate panels, for example six vacuum insulated panels which together can be arranged to abut each other to define a cuboid or cubic shape complementary to the shape of the payload retention volume. Alternatively the vacuum insulated panels may be provided by a pre-joined or pre-formed vacuum insulated vessel or base, for example having five sides, which define a five sides of a cuboid or cubic shape complementary to the shape of the payload retention volume, and a separate vacuum insulating panel to complete the cuboid or cube, for example for use as or in a lid.

Suitably the first or the second layer of insulation suitably comprises phase-change material containing vessels. Suitably the first layer of insulation is provided by vacuum insulation panels (VIPs) and the second layer of insulation is provided by phase-change material containing vessels (PCMs). Therefore the thermally insulated package suitably comprises a layer of vacuum insulation panels and a layer of phase-change material containing vessels. Suitably the phase-change material containing vessels define a payload retention volume and are therefore the innermost layer of insulation in the thermally insulated package.

The phase-change material containing vessels may be provided by discrete, separate vessels, for example six phase-change material containing vessels which together can be arranged to abut each other to define a cuboid or cubic shape complementary to the shape of the payload retention volume. Suitably the phase-change material containing vessels are arranged to abut each other in order to minimise any gaps between the phase-change material containing vessels which may admit air into the payload retention volume. It will be appreciated that even when the phase-change material containing vessels abut each other, the payload retention volume may not be completely air tight.

Suitable phase-change material containing vessels and phase-change materials contained within them are known in the art.

Suitably the vacuum insulation panels are arranged around the phase-change material containing vessels in order to minimise any gaps which may admit air through the insulation layer towards the payload retention volume. However, the insulation layer may not be completely air tight.

The thermally insulated package of this first aspect is suitably a modular package, suitably wherein the main body and at least one layer of insulation are collapsible. Such modular thermally insulated package systems are known in the art, without the adaptations for locking the package of the present invention. The thermally insulated package may therefore be assembled from component parts to form the enclosed payload retention volume. The component parts may be discrete, separate components with sizes and shapes chosen to allow assembly into an assembled thermally insulated package comprising the payload retention volume and the at least one layer of insulation. The component parts suitably comprise insulation components such as the vacuum insulation panels and the phase-change material containing vessels described above. The component parts suitably comprise structural components such as the openable panel, a base panel and side walls. The side walls may comprise four side walls, which may be provided as separate components or as a single component wherein the four side walls are joined or formed together.

Such a modular package can be placed in a collapsed configuration wherein no payload retention volume is present and the component parts of the thermally insulated package are arranged so that the modular package has a smaller total volume than in an assembled configuration comprising the payload retention volume. The smaller volume of the collapsed configuration is advantageous for storage and transportation of the modular package when no temperature sensitive payload is present, for example on a return journey after delivery of a temperature sensitive payload or when storing the modular package for future use.

The locking features of the thermally insulated package described herein may be particularly advantageous when the package is such a modular package, because such modular packages are generally less secure than more robust packages which aren't collapsible which can be provided with traditional, heavy, locking mechanisms. The arrangement of the functional device, the restraining member and the openable panel of the present invention suitably provide an efficient, convenient and relatively lightweight way of securing such a modular thermally insulated package to deter unwanted tampering with the package and temperature sensitive payload.

In such embodiments wherein the thermally insulated package is a modular package, the main body and the openable panel are suitably separable. Suitably the main body comprises four side walls and a base. Suitably the base is a base panel and is separable from the main body (i.e. the four side walls). The four side walls are suitably telescopic and are adjustable from a retracted position to an extended position, wherein in the collapsed configuration the four side walls are in the retracted position and in the assembled configuration the four side walls are in the extended configuration. The four side walls being telescopic suitably facilitates the re-arrangement of the thermally insulated package from the collapsed configuration to the assembled configuration, and vice versa.

In the thermally insulated package of this first aspect, the openable panel is suitably arranged as an upper face of the main body of the thermally insulated package.

The openable panel suitably comprises a groove for receiving side walls of the main body of the thermally insulated package. The groove is suitably arranged in a loop around the underside of the openable panel and matches the shape formed by the edges of the side walls of the main body. Therefore to close the thermally insulated package, the openable panel/lid is suitably arranged on the main body such that the edges of the side walls are located in the groove. When the thermally insulated package is locked by the functional device and the restraining member, the restraining member suitably presses the openable panel onto the side walls of the main body to prevent the movement of the openable panel away from the side walls. Lateral movement of the openable panel in relation to the side walls is prevented by the abutment of the side walls with sides of the groove. As such, the functional device, the restraining member and the openable panel function to effectively lock the thermally insulated package.

Suitably the base of the package is a base panel which has the features of the openable panel described above and is also pressed onto the side walls of the main body to prevent the movement of the base panel away from the side walls and also to prevent lateral movement of the openable panel in relation to the side walls, when the thermally insulated package is locked by the functional device and the restraining member. Suitably the openable panel and base panel are substantially identical, meaning that only one stock keeping unit is required to provide the base panel and openable panel (lid) of the package.

In some embodiments, the openable panel and the base panel comprise complementary outer profiles which can engage with each when one thermally insulated package is stacked on top of another, to facilitate the transport and/or storage of multiple thermally insulated packages.

The thermally insulated package of this first aspect may be provided with at least one smaller, secondary thermally insulated package within the payload retention volume of the (primary) thermally insulated package. The secondary thermally insulated package(s) suitably contain a payload retention volume, at least one layer of insulation surrounding the payload retention volume for transporting a temperature sensitive payload and an outer casing enclosing the at least one layer of insulation and the payload retention volume. The secondary thermally insulated package(s) suitably may be according to the first aspect of the present invention, therefore comprising a functional device and a restraining member for locking the package. The primary thermally insulated package may comprise a plurality of such secondary thermally insulated packages within the payload retention volume of the primary thermally insulated package. The plurality of secondary thermally insulated packages may be configured to maintain different specific internal temperatures of temperature sensitive payloads.

According to second aspect of the present invention, there is provided a kit for forming a thermally insulated package, the kit comprising:
insulation components for forming a payload retention volume surrounded by at least one layer of insulation;
structural components for forming a main body enclosing the at least one layer of insulation and the payload retention volume, including an openable panel;
a restraining member for engaging with the openable panel; and
a functional device configured to engage with the restraining member;
wherein the functional device is operable to selectively switch between a locked state and an unlocked state.

The thermally insulated package, insulation components, structural components, openable panel, restraining member and functional device may have any of the suitable features and advantages described in relation to the first aspect.

The functional device is suitably configured to engage with the restraining member and selectively hold the restraining member against the openable panel in a closed position when the functional device is in the locked state and to selectively release the restraining member when the functional device is in the unlocked state.

The kit of this second aspect may be a modular thermally insulated package in a collapsed configuration, as described above in relation to the first aspect.

According to third aspect of the present invention, there is provided a method of transporting a temperature sensitive payload, the method comprising the steps:
a) providing a thermally insulated package comprising a payload retention volume, at least one layer of insulation surrounding the payload retention volume and a main body enclosing the at least one layer of insulation and the payload retention volume, the main body comprising an openable panel;
b) placing the temperature sensitive payload into the payload retention volume;
c) closing the openable panel to close the thermally insulated package;
d) placing a restraining member over the openable panel;
e) locking the thermally insulated package closed by attaching a functional device to the restraining member and the openable panel, and activating a locked state of the functional device;
f) transporting the thermally insulated package and the temperature sensitive payload to a destination;
g) activating an unlocked state of the functional device, removing the restraining member from the functional device, opening the openable panel and removing the temperature sensitive payload from the thermally insulated package.

The thermally insulated package, openable panel, restraining member and functional device used in the method of this third aspect may have any of the suitable features and advantages described in relation to the first aspect.

Suitably the steps of the method are carried out in the order step a) followed by step b), followed by step c), followed by step d), followed by step e), followed by step f).

Step a) may involve assembling the thermally insulated package into an assembled configuration from insulation components and structural components as described above in relation to the first aspect, suitably from a kit according to the second aspect.

The method may involve a step g) of converting the thermally insulated package into a collapsed configuration having a smaller volume that the assembled configuration.

### BRIEF DESCRIPTION OF THE DRAWINGS

For a better understanding of the invention, and to show how example embodiments may be carried into effect, reference will now be made to the accompanying drawings in which:

FIG. 1 is a perspective view of a thermally insulated package 100 according to the first aspect of the present invention.

FIG. 2 is a plan view of the thermally insulated package 100.

FIG. 3 is a side-on perspective view of the thermally insulated package 100.

FIG. 4 is a plan view of the thermally insulated package 100.

FIG. 5 is a close-up perspective view of a restraining member for use with the thermally insulated package 100.

FIG. 6 is a cross-section view of a functional device and restraining member for use with the thermally insulated package 100.

### DETAILED DESCRIPTION OF THE EXAMPLE EMBODIMENTS

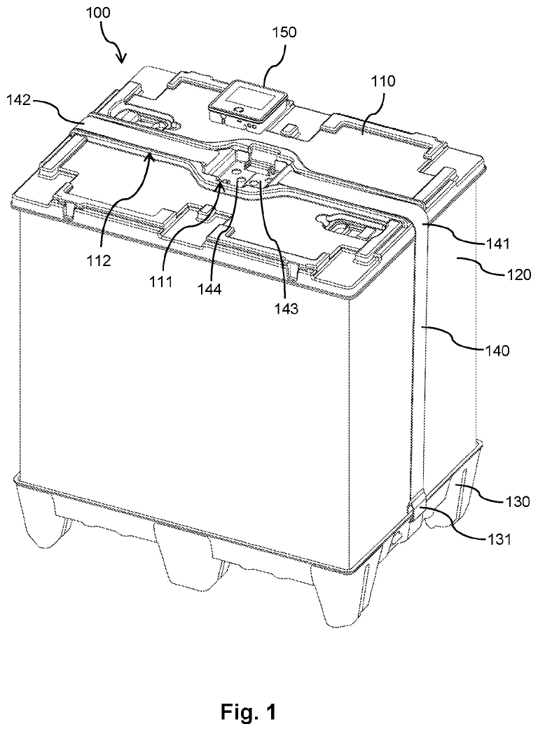

FIG. 1 shows a thermally insulated package 100 comprising an openable panel 110, a main body 120, a base panel 130, a restraining member 140 and a functional device with a locking function 150. The openable panel 110 is formed of a moulded hard-wearing polymeric material and forms the lid of the package 100. The base panel 130 is similarly formed of a moulded hard-wearing polymeric material. The main body 120 is provided by lightweight structural sheets formed of polymeric material. The openable panel 110 together with the main body 120 and base panel 130 form an outer casing for housing at least one layer of insulation surrounding a payload retention volume in which temperature sensitive payloads can be housed and transported. The thermally insulated package 100 is in a closed configuration with the inside of the package not accessible from outside.

The restraining member 140 is in the form of a two-part strap comprising two flexible portions 141 and 142 made of strong fabric material, each flexible portion 141 and 142 comprising an engagement portion 143 and 144, which may be formed of stainless steel. The engagement portions 143 and 144 as shown are identical to each other. However, in other embodiments, the engagement portions 143 and 144 may be different to each other. For example, the engagement portions 143 and 144 could have complementary profiles which interlock when the engagement portions are brought together for engagement with the functional device.

The functional device 150 comprises a locking function and data logging functionality, as described above. The functional device 150 may be provided by a Smartlock device supplied by Tec4med Lifescience GmbH. The functional device 150 is shown slightly removed from the openable panel 110 in order to show the engagement portions 143 and 144 of the restraining member. The locking function is provided by locking members (not shown) arranged on the back side of the functional device.

The openable panel 110 comprises a recess 111 for accommodating the functional device 150 and the engagement portions 143 and 144 of the restraining member 140 in a reasonably tight fit to prevent significant lateral movement of the functional device 150 and the engagement portions 143 and 144. The recess 111 is located centrally on the openable panel 110. In some embodiments, the recess may be located off-centre on the openable panel 110, in at least one dimension with respect to the plane of the upper surface of the openable panel. The recess 111 may be placed in such an off-centre position in order to avoid contact of the functional device 150 in the recess 111 with a supporting foot of a package placed on top of the thermally insulated package 100 in a stack. Some such stackable packages are provided with supporting feet and may have one of the supporting feet in the centre of the package, which would contact and potentially damage the functional device 150 in a central recess 111 as shown. The central location of the recess 111 may be preferable in packages which do not comprise such central supporting feet.

The openable panel 110 also comprises a channel 112 for receiving and retaining the two flexible portions 141 and 142 of the restraining member 140, to prevent lateral movement of the restraining member 140 when the package is in a locked state. The base panel 130 comprises two loops 131 which act as tethers for ends of the flexible portions 141 and 142 of the restraining member, when the flexible portions are fixed onto the loops as shown.

In an alternative embodiment, the restraining member may comprise a single continuous strap with the engagement portion 143 and 144 at either end of the strap. In such embodiments, the base panel suitably comprises a channel as described in relation to the openable panel or retaining loops through which strap passes in order to hold the strap onto the package. In such embodiments, the tethers 131 and 132 discussed above are not required or are used to pass through the single continuous strap, rather than to fix the two-part strap to.

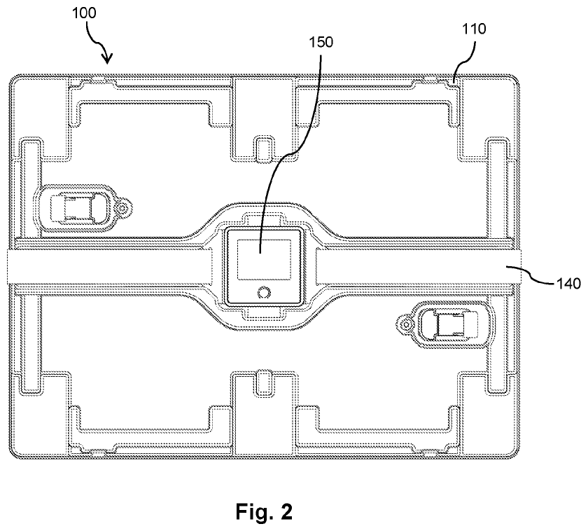

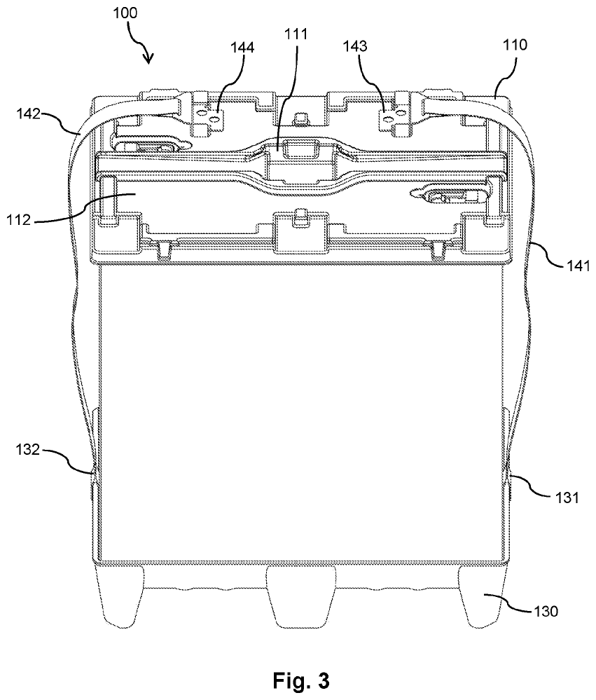

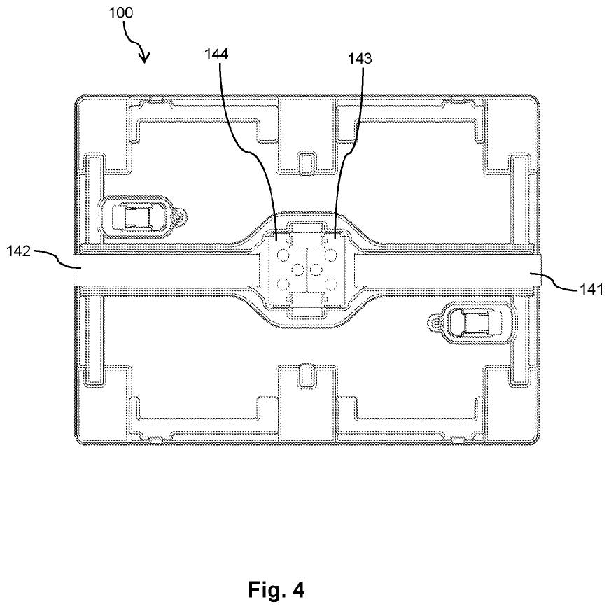

The thermally insulated package 100 may be locked using the restraining member 140 and the functional device 150, as follows. Once the package has been loaded with a temperature sensitive payload and the openable panel 110 placed onto the main body 120 of the package, the two flexible portions of the strap 141 and 142 are located in the channel and the two engagement portions of the strap 143 and 144 are placed in the recess 111 of the openable panel 110, as shown in FIG. 1 and in the transition from FIG. 3 to FIG. 4. In the recess 111, the two engagement portions meet and abut each other at opposing ends. The functional device is lowered into the recess 111 on top of the engagement portions of the strap 143 and 144, which effectively form another recess for the functional device 150. The functional device 150 is arranged in the recess 111 and in the engagement portions 143 and 144 with the back side comprising the locking members facing downwards towards the recess 111 and the engagement portions, as shown in FIG. 2. The thermally insulated package 100 is then in a closed configuration and is ready to be locked.

In order to lock the thermally insulated package 100, the functional device is activated by either a manual input from a user or using a signal from a remote source. This causes the locking members of the functional device 150 to engage with the engagement portions of the strap 143 and 144 in order to lock the engagement portions and therefore the two parts of the strap together so they cannot be easily separated manually, and also to lock the functional device 150 onto the engagement portions so that the device cannot be easily removed from the engagement portions and therefore from the package. This action of the locking members of the functional device 150 and the tethers 131 and 132 holds the strap 140 over the openable panel 130 with sufficient tension to prevent the openable panel and the base panel 130 from separating from the main body 120 and to prevent access to the inside of the package. The thermally insulated package is therefore effectively locked in the closed state and access to the inside of the package is prevented.

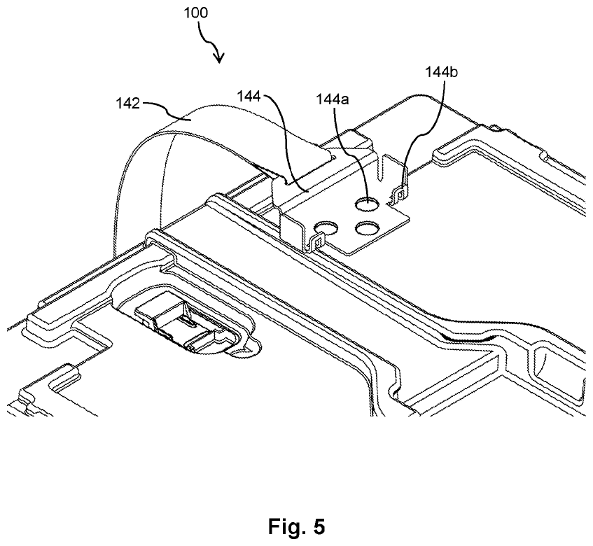

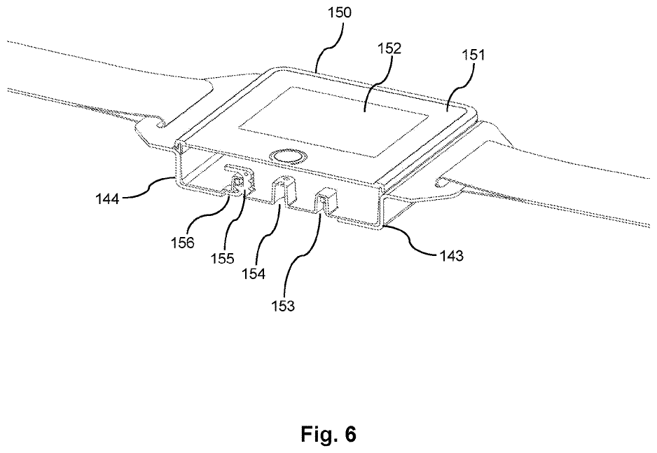

FIGS. 5 and 6 show more detail of the locking members and the engagement portions. FIG. 5 shows one engagement portion 144 of the restraining member 140. The engagement portion 144 comprises three through holes 144a and two loops 144b. The through holes 144a are positioned and sized to receive pistons 154 of the functional device 150 when the functional device is in the locked state and the pistons are extended from the rear side 153 of the functional device. The loops 144b are shaped and positioned to engage with hooks 155 arranged inside the functional device 150 as shown in FIG. 6. When the functional device is arranged on the engagement portions as shown in FIG. 6, the loops 144b enter a complementary slot 156 in the 153 face of the functional device in which the hooks 155 are retained on a pivot and biased into a closed position. The entry of the loop 144b into the slot 156 causes the hook 155 to be pushed back on the pivot allowing the loop to pass over the hook and then spring back into the centre of the loop to retain the loop in the slot and so secure the functional device 150 to the engagement portion 144, when the rear face 153 of the functional device 150 contacts the engagement portion.

Similarly, the corresponding pistons 154 and hooks 155 engage with the through holes 143a and the loops 143b on the other engagement portion 143 (not shown in FIG. 5). These engagement actions of the pistons 154 and hooks 155 from the functional device 150 in the locked state secure the engagement portions 143 and 144 together and secure the functional device 150 to the engagement portions, to lock the thermally insulated package 100 as described above in relation to FIG. 1.

The thermally insulated package is unlocked by providing an appropriate input to the functional device 150 which activates the device to switch from the locked state to the unlocked state. The input may be a command signal from a remote source, for example a signal sent from an operator via a long-range telecommunications network. In switching to the unlocked state, the pistons 154 retract out of the through holes 143a and 144a of the engagement portions 143 and 144 into the base of the functional device 150, and the hooks 155 are actuated to pivot out of the loops 143b and 144b so that the loops are no longer retained by the hooks in the slots 156. The functional device 150 can then be removed from the engagement portions 143 and 144, and the restraining member 140 can be removed from the openable panel 110, allowing the thermally insulated package to be opened and the temperature sensitive payload to be removed.

The embodiment described above demonstrates how the functional device 150, restraining member 140 and openable panel 110 of the thermally insulated package 100 operate to provide a convenient and effective locking mechanism which can be used to improve the security and reliability of such packages in the transport of temperature sensitive payloads, particularly when used with modular thermally insulated package systems.

Although a few preferred embodiments have been shown and described, it will be appreciated by those skilled in the art that various changes and modifications might be made without departing from the scope of the invention, as defined in the appended claims.

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention. Typically, when referring to compositions, a composition consisting essentially of a set of components will comprise less than 5% by weight, typically less than 3% by weight, more typically less than 1% by weight of non-specified components.

The term “consisting of” or “consists of” means including the components specified but excluding addition of other components.

Whenever appropriate, depending upon the context, the use of the term “comprises” or “comprising” may also be taken to encompass or include the meaning “consists essentially of” or “consisting essentially of”, and may also be taken to include the meaning “consists of” or “consisting of”.

The optional features set out herein may be used either individually or in combination with each other where appropriate and particularly in the combinations as set out in the accompanying claims. The optional features for each aspect or exemplary embodiment of the invention as set out herein are also to be read as applicable to any other aspect or exemplary embodiments of the invention, where appropriate. In other words, the skilled person reading this specification should consider the optional features for each exemplary embodiment of the invention as interchangeable and combinable between different exemplary embodiments.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, and drawings), and/or all of the steps of any method or process so disclosed, may be combined in any combination, except combinations where at least some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, and drawings), or to any novel one, or any novel combination, of the steps of any method or process so disclosed.

1. A thermally insulated package for transporting a temperature sensitive payload, the thermally insulated package comprising:
a payload retention volume;
at least one layer of insulation surrounding the payload retention volume;
a main body enclosing the at least one layer of insulation and the payload retention volume, wherein the main body comprises an openable panel;
a restraining member for retaining the openable panel in a closed position; and
a functional device having a locked state and an unlocked state;
wherein the functional device is configured to engage with the restraining member and selectively hold the restraining member against the openable panel in a closed position when the functional device is in the locked state and to selectively release the restraining member when the functional device is in the unlocked state.

2. The thermally insulated package according to claim 1, wherein the functional device is configured to record and/or communicate an internal parameter of the thermally insulated package.

3. The thermally insulated package according to claim 1, wherein the functional device is configured for remote operation by a command signal to selectively switch the functional device between the locked state and the unlocked state.

4. The thermally insulated package according to claim 1, wherein the functional device is removable from the thermally insulated package when in the unlocked state.

5. The thermally insulated package according to claim 1, wherein the openable panel comprises a recess for receiving the functional device.

6. The thermally insulated package according to claim 1, wherein the functional device is configured to be secured to the openable panel and the restraining member when in the locked state.

7. The thermally insulated package according to claim 1, wherein the functional device comprises locking members which engage with the restraining member when the functional device is in the locked state.

8. The thermally insulated package according to claim 1, wherein the restraining member comprises at least one engagement portion for engaging with the functional device, when the functional device is in the locked state.

9. The thermally insulated package according to claim 7, wherein the openable panel comprises a recess for receiving the engagement portion of the restraining member.

10. The thermally insulated package according to claim 1, wherein the restraining member comprises a flexible portion.

11. The thermally insulated package according to claim 1, wherein the package comprises at least one tether for receiving the restraining member.

12. The thermally insulated package according to claim 1, wherein the restraining member comprises at least two sections which connect to the functional device when the restraining member is in the closed position and the functional device is in the locked state.

13. The thermally insulated package according to claim 1, wherein the package is a modular package wherein the main body and at least one layer of insulation are collapsible.

14. The thermally insulated package according to claim 1, wherein the openable panel is arranged as an upper face of the main body of the thermally insulated package.

15. The thermally insulated package according to claim 1, wherein the openable panel comprises a groove for receiving side walls of the main body of the thermally insulated package.

16. The thermally insulated package according to claim 1, wherein the at least one layer of insulation surrounding the payload retention volume comprises vacuum insulated panels and/or phase-change material containing vessels.

17. The thermally insulated package according to claim 1, wherein functional device is adapted to record data of instances of the functional device being switched between the locked state and the unlocked state and/or to communicate said data to a remote user.

18. The thermally insulated package according to claim 1, comprising a temperature sensor inside the payload retention volume and a location sensor, wherein the functional device is adapted to communicate data from the temperature sensor and the location sensor, to a remote user.

19. A kit for forming a thermally insulated package, the kit comprising:
insulation members for forming a payload retention volume surrounded by at least one layer of insulation;
structural components for forming a main body enclosing the at least one layer of insulation and the payload retention volume, including an openable panel;
a restraining member for engaging with the openable panel; and
a functional device configured to engage with the restraining member;
wherein the functional device is operable to selectively switch between a locked state and an unlocked state.

20. A method of transporting a temperature sensitive payload, the method comprising the steps:
a) providing a thermally insulated package comprising a payload retention volume, at least one layer of insulation surrounding the payload retention volume and a main body enclosing the at least one layer of insulation and the payload retention volume, the main body comprising an openable panel;
b) placing the temperature sensitive payload into the payload retention volume;
c) closing the openable panel to close the thermally insulated package;
d) placing a restraining member over the openable panel;
e) locking the thermally insulated package closed by attaching a functional device to the restraining member and the openable panel, and activating a locked state of the functional device;
f) transporting the thermally insulated package and the temperature sensitive payload to a destination;
g) activating an unlocked state of the functional device, removing the restraining member from the functional device, opening the openable panel and removing the temperature sensitive payload from the thermally insulated package.
